(19) United States
(12) Patent Application Publication
(10) Pub. No.: US 2020/0068856 A1
(43) Pub. Date: Mar. 5, 2020

(54) HONEYBEE COLLECTOR

(71) Applicants: James Raymond Ford, Riley Twp, MI (US); Keith Michael Lazar, Farmington Hills, MI (US)

(72) Inventors: James Raymond Ford, Riley Twp, MI (US); Keith Michael Lazar, Farmington Hills, MI (US)

(21) Appl. No.: 16/557,431

(22) Filed: Aug. 30, 2019

Related U.S. Application Data
(60) Provisional application No. 62/724,946, filed on Aug. 30, 2018.

(51) Int. Cl. A01K 49/00

(52) U.S. Cl. CPC A01K 49/00

(57) ABSTRACT

A honeybee collector includes a collector body having a sidewall with an outer surface and an inner surface. The inner surface defines a brood frame slot and a funnel defined below the brood frame slot. The funnel is angled towards a bottom opening defined by a bottom rim of the sidewall. An upper rim of the sidewall defines a top opening leading into the brood frame slot, and the brood frame slot is sized to receive a brood frame. A catch bottle is used for catching bees. A connector couples a mouth of the catch bottle to the bottom rim of the collector body.

### CROSS-REFERENCE TO RELATED APPLICATION

This application claims the benefit of priority of U.S. provisional application No. 62/724,946, filed Aug. 30, 2018 the contents of which are herein incorporated by reference.

### BACKGROUND OF THE INVENTION

The present invention relates to collecting honeybees for testing and, more particularly, to a device that easily collects and contains honeybees.

Varroa destructor (Varroa mite) is an external parasitic mite that attacks and feeds on honeybees. The Varroa mite is the parasite with possibly the most pronounced economic impact on the beekeeping industry. Varroa is considered to be one of multiple stress factors contributing to the higher levels of bee losses around the world.

The current process for checking for Varro mites involves shaking bees into an open container with the honeybees flying all around and not contained. For the beekeeper the process of shaking bees into a bucket and trying to scoop a specific amount of bees in a scoop and then trying to get the correct quantity into a jar is believed to cause stress on the honey bees, which in turn, makes them aggressive toward the beekeeper, possibly causing harm to himself and/or the bees.

As can be seen, there is a need for a device that easily collects and contains honeybees.

### SUMMARY OF THE INVENTION

In one aspect of the present invention, a honeybee collector comprises: a collector body comprising a sidewall having an outer surface and an inner surface, wherein the inner surface defines a brood frame slot and a funnel below the brood frame slot, wherein the funnel is angled towards a bottom rim of the sidewall defining a bottom opening, wherein an upper rim of the sidewall defines a top opening leading into the brood frame slot, and the brood frame slot is sized to receive a brood frame.

These and other features, aspects and advantages of the present invention will become better understood with reference to the following drawings, description and claims.

### BRIEF DESCRIPTION OF THE DRAWINGS

FIG. 1 is a front perspective view of an embodiment of the present invention;

FIG. 2 is a rear perspective exploded view of an embodiment of the present invention;

FIG. 3 is a section view of the present invention, taken along line 3-3 in

FIG. 1;

FIG. 4 is a perspective view of an embodiment of the present invention, illustrating insertion of a brood frame;

FIG. 5 is a perspective view of an embodiment of the present invention, illustrating an inserted brood frame;

FIG. 6 is a perspective view of a catch bottle and a lid of an embodiment of the present invention;

FIG. 7 is a perspective view of a catch bottle, a lid, and a media bottle of an embodiment of the present invention;

FIG. 8 is a perspective view of a catch bottle, a lid, and a media bottle of an embodiment of the present invention;

FIG. 9 is a section view of the present invention, taken along line 9-9 in

FIG. 8;

FIG. 10 is a section view of an embodiment of the present invention;

FIG. 11 is a perspective view of an embodiment of the present invention, shown in use; and

FIG. 12 is a flow chart of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a honeybee collector to check honeybees for varroa mites. The honeybee collector allows the beekeeper to preload powdered sugar or alcohol depending on method of testing, into a marked bottle which is attached to the bottom of the honeybee collector. Simply insert the frame of bees into the honeybee collector and shake one or two times until the bees fill to the line on the connected bottle. into Then unscrew bottle and put on a custom lid and continue with a Varro mite check. The present invention eliminates the initial steps from the current procedure (shaking, scooping, and dumping the bees). By using the present invention, there is virtually no harm/stress to the honeybees and/or the beekeeper.

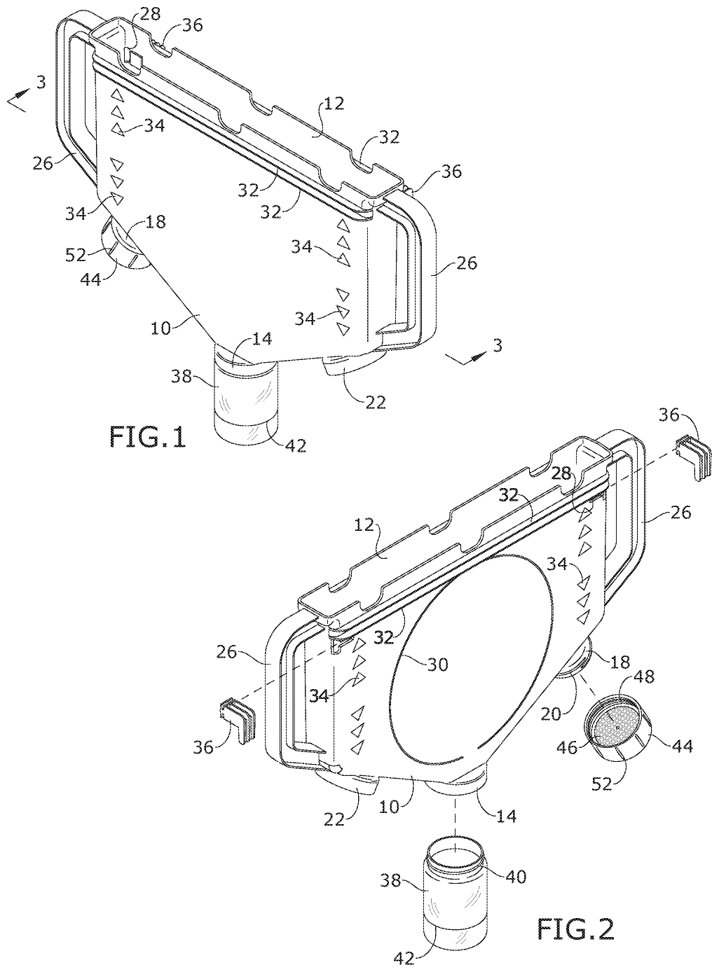

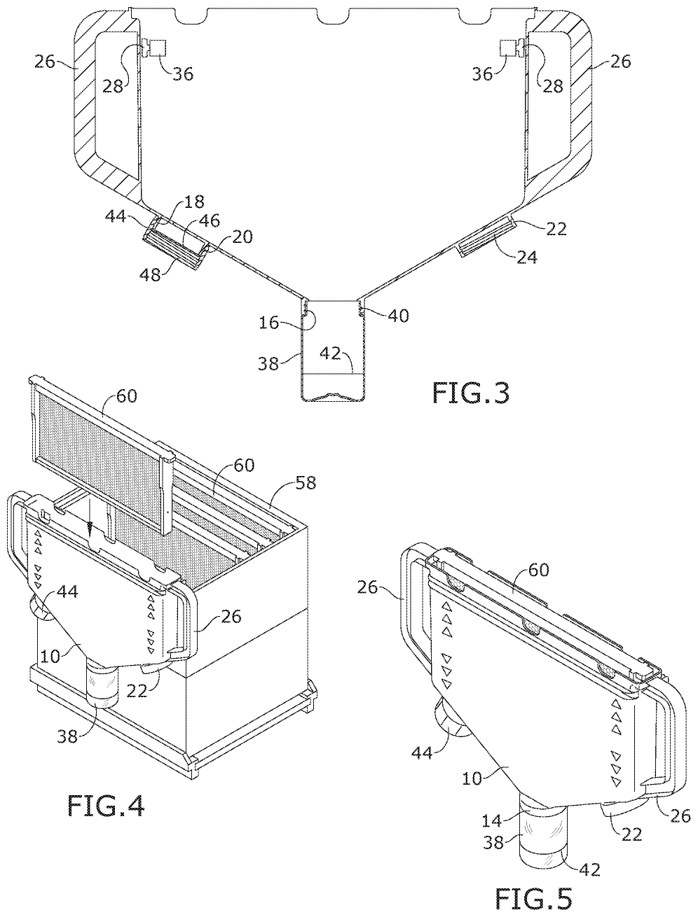

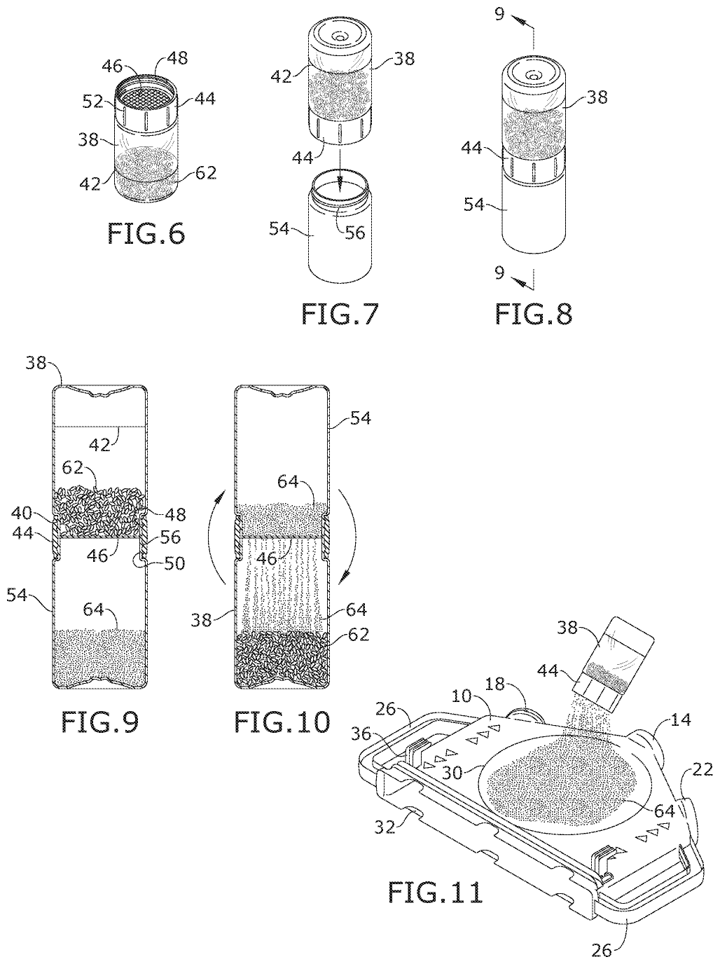

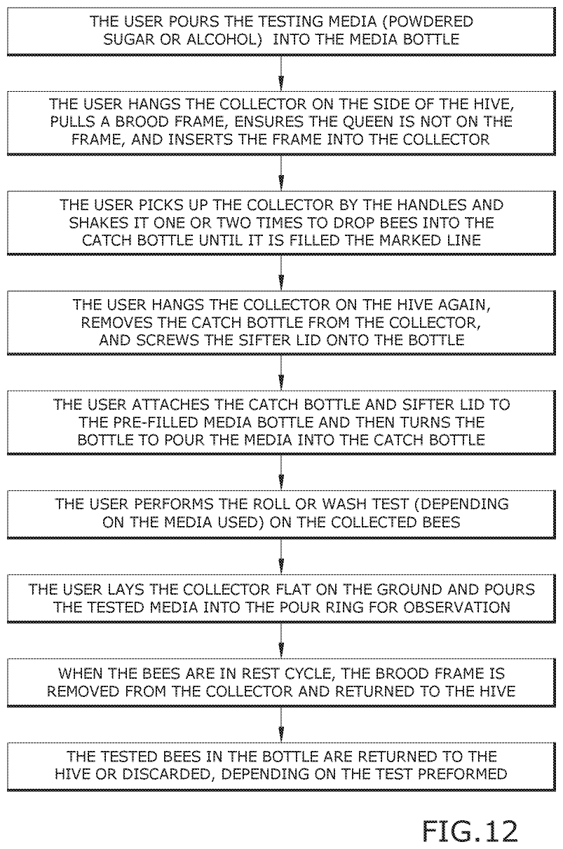

Referring to FIGS. 1 through 12, the present invention includes a honeybee collector having a collector body 10. The collector body 10 includes a sidewall having an outer surface and an inner surface. The outer surface includes a front, a rear, sides, and a bottom. The inner surface defines a brood frame slot 12 and a funnel defined below the brood frame slot 12. The funnel is angled towards a bottom opening defined by a bottom rim 14 of the sidewall. An upper rim of the sidewall defines a top opening leading into the brood frame slot 12, and the brood frame slot 12 is sized to receive a brood frame 60. For example, the brood frame slot 12 defines a rectangular cuboid shape sized to snuggly receive a rectangular shaped brood frame 60.

The present invention may further include a catch bottle 38 for catching bees 62. A connector may couple a mouth of the catch bottle 38 to the bottom rim 14. The connector may include threaded connectors, snaps, clips, clamps, and the like. For example, the bottom rim 14 of the sidewall may include female threads 16 and the mouth of the catch bottle 38 may include male threads 40 mechanically fastened to the female threads 16 of the bottom rim 14. When the catch bottle 28 is connected to the bottom rim 14, the brood frame 60 may be placed within the brood frame slot 12 and the user may shake the collector body 10 up and down. The shaking moves honeybees 62 into the catch bottle 38. A line indicator 42 may be printed on the catch bottle 38 to guide a user on how many bees to capture.

The present invention may further include a sifter lid 44 and a media bottle 54. The sifter lid 44 includes a screen 46 and connectors such as, but not limited to, threaded connectors, snaps, clips, clamps, and the like. For example, the sifter lid 44 may include includes upper female threads 48, lower female threads 50, and a screen 46 disposed in between the connectors. The screen 46 may include a plastic or wire mesh. Additionally, the media bottle 54 may include male threads 56. A media 64 may be placed within the media bottle 54. The sifter lid 44 may be mechanically fastened to the mouth of the media bottle 54 and the catch bottle 38 by the upper and lower female threads 48, 50 respectively. Lid grip ribs 52 protrude from the outer surface of the sifter lid 44 to aid the user's grip. A user may then rotate the connected media bottle 54 and catch bottle 28 to pour the media 64 into the catch bottle 28 and onto the honeybees 62.

In certain embodiments, the media bottle 54 and the sifter lid 44 may releasably fasten to the collector body 10 when the honeybee collector is not in use. In such embodiments, the collector body 10 may further include a female post 22 extending from the bottom of the outer surface and having female threads 24, and a male post 18 extending from the bottom of outer surface having male threads 20. The sifter lid 44 is mechanically coupled to the male post 18 and the media bottle 54 is mechanically fastened to the female post 22.

For ease of use, the honeybee collector may further include hooks 36, handles 26, and a leveler 32. The hooks 36 may protrude from the front of the outer surface of the collector body 10. For example, the outer surface of the collector body 10 may include hook slots 28. The hooks 36 snap into the hook slots 28. The hooks 28 allow a user to hang the collector body 10 on a beehive 58 while removing the brood frame 60 from the beehive 58. The leveler 32 is a lip that extends from the front of the collector body 10 and rests on the upper edge of the beehive 58. The handles 26 extend from the sides of the outer surface of the collector body 10 and allow a user to easily grasp the connector body 10 with protective gloves.

The outer surface of the collector body 10 may also include guides for the user. For example, up and down arrows 34 may be printed on the outer surface to illustrate that the collector body 10 is to be shaken up and down to shake the bees out into the catch bottle 28. Additionally, a pour ring 30 may be printed on the front of the outer surface to illustrate where to pour the media 46 out of the catch bottle 28 after mixing the media 46 with the honeybees 62.

Referring to FIG. 12, the honeybee collector allows the beekeeper to preload the powdered sugar or alcohol into the media bottle which is detached from the bottom of the honeybee collector. The beekeeper then goes into the beehive brood chamber. The beekeeper hangs the honeybee collector on the side of the hive and once the beekeeper pulls a brood frame and ensures the queen bee is not on it, the frame is inserted into the honeybee collector. The beekeeper then grasps the honeybee collector by the integrated handles and shakes one or two times until the bees fill to the line on the connected bottle. The beekeeper then hangs the honeybee collector, unscrews the catch bottle and connects the lid to the catch bottle. The user attaches the catch bottle and sifter lid to the pre-filled media bottle and then turns the bottle to pour the media into the catch bottle. The user then performs the roll or wash test on the collected bees. The user lays the collector flat on the ground and pours the tested media into the pour ring for observation. When the bees are in rest cycle, the beekeeper simply returns the frame of bees to the hive, gently shakes any residual bees out into the hive, and assembles the hive to the inner cover. After powdered sugar roll is complete, the bees are poured onto the inner cover for hyper-grooming and for alcohol wash the dead bees are discarded.

It should be understood, of course, that the foregoing relates to exemplary embodiments of the invention and that modifications may be made without departing from the spirit and scope of the invention as set forth in the following claims.

What is claimed is:

1. A honeybee collector comprising:
a collector body comprising a sidewall having an outer surface and an inner surface, wherein the inner surface defines a brood frame slot and a funnel defined below the brood frame slot, wherein the funnel is angled towards a bottom opening defined by a bottom rim of the sidewall, wherein an upper rim of the sidewall defines a top opening leading into the brood frame slot, and the brood frame slot is sized to receive a brood frame.

2. The honeybee collector of claim 1, wherein the brood frame slot defines a rectangular cuboid shape sized to snuggly receive a rectangular shaped brood frame.

3. The honeybee collector of claim 1, wherein the outer surface comprises a front, a rear, sides, and a bottom, wherein the bottom comprises the bottom rim and the bottom rim comprises female threads.

4. The honeybee collector of claim 3, further comprising a catch bottle comprising male threads mechanically fastened to the female threads of the bottom rim.

5. The honeybee collector of claim 4, further comprising a sifter lid comprising upper female threads, lower female threads, and a screen disposed between the upper and lower female threads.

6. The honeybee collector of claim 5, further comprising a media bottle comprising male threads.

7. The honeybee collector of claim 6, wherein the collector body further comprises a female post extending from the outer surface having female threads, and a male post extending from the outer surface having male threads, wherein the sifter lid is mechanically coupled to the male post and the media bottle is mechanically fastened to the female post.

8. The honeybee collector of claim 1, further comprising hooks extending from the outer surface of the collector body.

9. The honeybee collector of claim 8, wherein the hooks are removeably attached within hook slots of the collector body.

10. The honeybee collector of claim 3, further comprising handles extending from the sides of the outer surface of the collector body.
